(19) United States
(12) Patent Application Publication
(10) Pub. No.: US 2005/0075902 A1
(43) Pub. Date: Apr. 7, 2005

(54) Computerized system and method for determining work in a healthcare environment

(76) Inventors: Douglas W. Wager, Kansas City, MO (US); Jay E. Linney, Kansas City, MO (US)

Correspondence Address: SHOOK, HARDY & BACON L.L.P., 2555 GRAND BOULEVARD, KANSAS CITY, MO, 64108-2613, US

(21) Appl. No.: 10/679,836

(22) Filed: Oct. 6, 2003

(51) Int. Cl. G06F 17/60

(52) U.S. Cl. 705/2

(57) ABSTRACT

A method in a computing environment for determining the work for one or more patients is provided. The method includes obtaining data for one or more patients directly from the primary clinical information system and utilizing the data to calculate work for the one or more patients. A method in a computing environment for determining the work for a population of patients is provided. The method comprises utilizing data obtained directly from the primary clinical information system to calculate a work score for each patient in a patient population and calculating staffing needs for the population based on the work scores obtained for the patients in the patient population.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to the field of computer software. More specifically, the present invention also relates to a method for determining the amount of work for one or more patients in a healthcare environment. The present invention also relates to a system for optimizing personnel planning and allocation in a healthcare environment.

### BACKGROUND OF THE INVENTION

Healthcare organizations must identify whether they have staff capacity to deliver an appropriate level of care based on the needs of a given patient population. These organizations are also required to prove that they are staffing properly under governmental rules. However, healthcare organizations trail other industries in the quality and efficiency of their management of workforce and production issues.

Traditionally, workforce management in the healthcare industry has been remarkably reactionary. For instance, a nurse manager will mentally calculate the number of workers needed for their unit based on the number of patients in the unit and will have to shift personnel based on the number of patients. This method of workforce management is ineffective and time consuming. Other methods for determining patient classification or workload for a patient population include the VanSlyck methodology and the GRASP methodology. The VanSlyck methodology, a ‘factor-based’ patient classification method, assigns each patient a classification of 1-7 depending on the characteristics of the patient. Some of the characteristics taken into account include hygiene, mobility and psychosocial issues. The resulting patient classification is related to the number of hours of nursing care required to treat the patient by means of staffing standards derived from activity studies performed for the organization. The GRASP methodology, a ‘time-intervention’ model, assigns relative value units (RVU) to different tasks performed for the patient. For instance, starting an IV for a patient may be given a relative value unit of 1, indicating 1/10 of an hour of time. Both of these methodologies have been proven successful in various areas of care estimation.

However, these and other methodologies for determining the patient classification or workload associated with a patient require manual entry and calculation of information either on paper or into a disparate computer system that is not integrated with the primary clinical information system. As such, these methodologies do not capture the data during the planning and documenting of care in the primary clinical information system and are time consuming and prone to error.

What is needed is a cost-effective and accurate way of capturing patient classification and workload information as a result of planning and documenting care in the primary clinical information system, and utilizing that information for determining the number of healthcare workers needed for a particular patient population. Also needed is a method and system for concurrently automating multiple processes for determining patient classification or workload as a result of healthcare professionals planning and documenting care in a single system. A system and method is needed for planning and measuring effectiveness of staff allocation with respect to clinical orders and outcomes.

### SUMMARY OF THE INVENTION

In one aspect of the present invention, a system and method in a computing environment for determining the work for one or more patients is provided. The method obtains data for one or more patients directly from the primary clinical information system and utilizes the data to calculate work for the one or more patients. A work score may be a patient classification score, a workload score or any value that ultimately reflects the amount of work or time it takes to treat a patient or patient population. The method also automates existing proven methodologies designed to produce patient classification and workload information.

In another aspect of the present invention, a method in a computing environment for determining the work for a population of patients is provided. The method utilizes data obtained directly from the primary clinical information system to calculate a work score for each patient in a patient population and calculates staffing needs based on the work scores obtained for the patients in the patient population.

In yet another embodiment, a computerized system for optimizing personnel planning in a healthcare organization is provided. The system includes a work calculation module for calculating a work score for one or more patients and a staff scheduling and staffing module for identifying healthcare personnel positions to be filled. The system also includes a role management module for managing the roles and information regarding personnel and a workforce outcomes module for determining how effectively healthcare personnel have been used. Finally, the system includes a demand forecast module for forecasting the volume and type of patients who will present and a resource dashboard module for displaying information regarding personnel and patients.

In still another embodiment, a computer-readable medium having computer-executable instructions for performing a method is provided. The method obtains data for one or more patients directly from the primary clinical information system and utilizes the data to calculate work for the one or more patients.

In yet another embodiment of the present invention, a computer-readable medium having computer-executable instructions for performing a method. The method utilizes data obtained directly from the primary clinical information system to calculate a work score for each patient in a patient population and calculates staffing needs for the department based on the work scores obtained for the patients in the patient population.

### BRIEF DESCRIPTION OF THE DRAWINGS

The present invention is described below in detail with reference to the attached drawing figures, wherein:

FIG. 1 is a block diagram of a computing system environment of an embodiment of the present invention;

FIG. 2 is a flow diagram of a method for calculating the amount of work for a particular patient population in accordance with an embodiment of the present invention;

FIG. 3 is a flow diagram of a method for calculating the amount of work for a patient in accordance with an embodiment of the present invention;

FIG. 4 is a staff assignment screen shot in accordance with an embodiment of the present invention;

FIG. 5 is a resource dashboard screen shot in accordance with an embodiment of the present invention.

FIG. 6 is a patient classification view/entry screen shot in accordance with an embodiment of the present invention;

FIG. 7 is a factor management screen shot in accordance with an embodiment of the present invention; and

FIG. 8 is a template screen shot in accordance with an embodiment of the present invention.

### DETAILED DESCRIPTION OF THE INVENTION

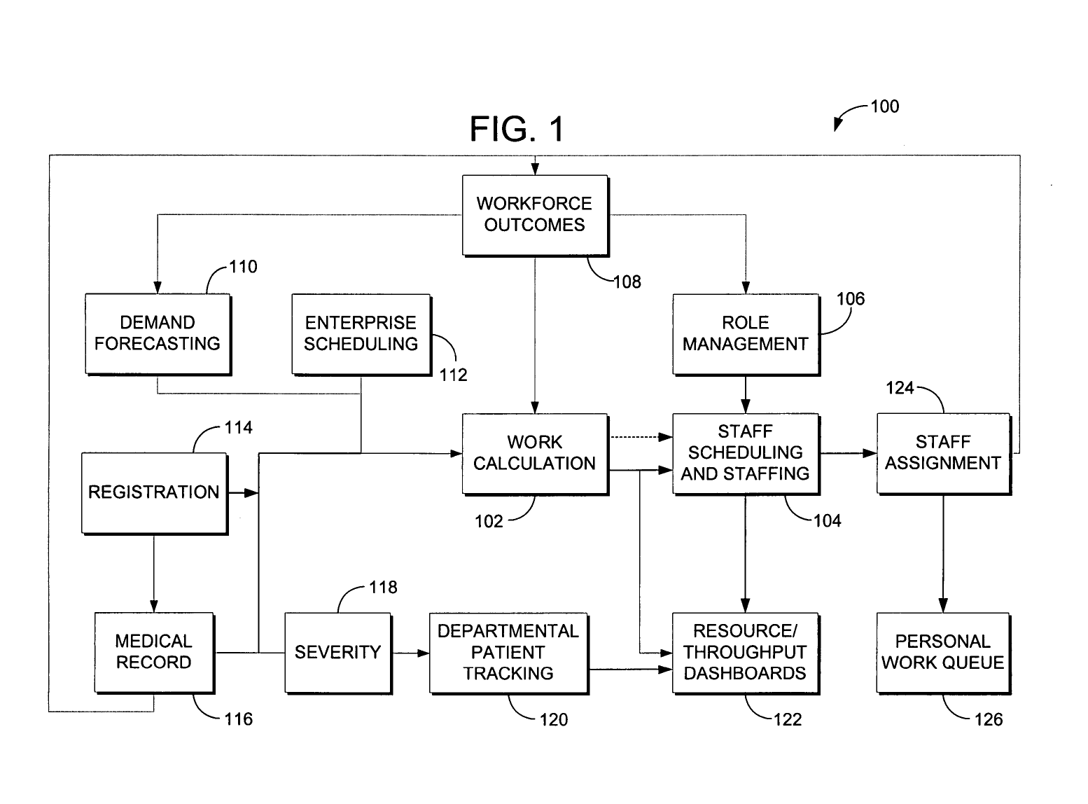

With reference to FIG. 1, a system for determining optimizing personnel planning and allocation 100 in a healthcare organization is provided. The system is a workforce management system that is continuously updated, end-to-end process supported by computer modules that help healthcare organizations optimize personnel planning and allocation based on forecasting and measuring clinical demand. The modules are used to automate complex, rules-driven processes and communicate the information needed by personnel to make operational decisions on personnel planning and allocation. The modules include, but are not limited to, a work calculation module 102, a staff scheduling and staffing module 104, a role management module 106, a workforce outcomes module 108, a demand forecasting module 110, an enterprise scheduling module 112, a registration module 114, a medical record module 116, patient severity module 118, a departmental patient tracking module 120, a resource/throughput dashboard module 122, a shift assignment module 124 and a personal work queue module 126. The modules of the present invention construct an integrated, end-to-end system with a continuous feedback loop but can also be implemented independently.

The work calculation module 102 of the present invention captures information for one or more patients directly from the primary clinical information system and generates a work score for one or more patients. In one embodiment the information for one or more patients may be captured from the medical record module 116. The work calculation module 102 identifies the quantity of personnel hours required to serve a given patient and/or patient population.

The work calculation for a patient population can be used to help managers make decisions on how to allocate staff, as well as to determine whether scheduled personnel will be able to meet the workload. The work calculation is designed to utilize any broadly recognized and/or scientifically based acuity or workload calculation models and automatically obtains information from the primary clinical information system to generate a work score for a patient and/or a patient population. The work cumulated may be the actual, retrospective, prospective or combinations thereof of the amount of work for a particular population. In one embodiment, the work calculation of the actual staff demand and the forecasted staff demand may be sent to the staff scheduling and staffing module 104 and/or to the resource/throughput dashboard module 122.

Staff scheduling and staffing module 104 identifies the positions that need to be filled to cover anticipated clinical demand and automates the process of matching personnel to positions that need to be filled. In one embodiment, the staff scheduling and staffing module 104 receives input from the work calculation module 102 about prospective workload and input from the demand forecast module 110 to help determine the anticipated clinical demand. The staff scheduling and staffing module also manages personnel preferences. The staff scheduling and staffing module stores information regarding Nurse Smith's preferences and any organized labor rules. For example, Nurse Smith prefers only available to work in the ICU on Monday, Wednesday, and Friday.

The staff scheduling and staffing module 104 allows a manager to adjust personnel on a real-time or short-term prospective basis when the scheduled staff changes (for instance, a staff member calls in sick), or when the clinical demand is higher or lower than forecasted. In this case, the staff scheduling and staffing receives actual work calculation from the work calculation module 102, compares the actual work calculation to the capacity of the scheduled/actual personnel on hand and gives displays the difference. In one embodiment, the difference is displayed within the staff scheduling and staffing module 104 or resource/throughput dashboard module 122. The staff scheduling and staffing module 104 can also adjust the staff scheduling levels appropriately based a rules engine. An example of a staff-scheduling module that may be used with the present invention is a staff-scheduling module designed by VasTech, Inc.

The role management module 106 manages the roles of personnel. For example, role management module 106 identifies the capabilities and authorization of personnel to provide services or perform tasks in a healthcare organization. The role management module 106 manages information regarding the competency level of personnel such as the skills, attributes and abilities of any worker or group of workers. The role management module 106 also manages information regarding licenses and certifications of any worker or group of workers. The role management module 106 manages the security and clinical privileges of any worker or group of workers and any information regarding the training of a worker or group of workers.

The role management module receives input from the clinical information system that can update personnel information. In one embodiment, the role management module 106 communicates personnel information with the staff scheduling and staffing module 104 so that the staff schedule and staffing module 104 can match the personnel with the correct position.

The workforce outcomes module 108 combines personnel allocation performance information with clinical, service, and financial performance indicators to help healthcare organizations analyze how efficiently and effectively they have deployed personnel. The workforce outcomes module 108 gathers data from a variety of other modules and systems including human resources information systems, time and activity systems, payroll, the staff-scheduling module, clinical databases and the work calculation module 102 in order to display key performance indicators related to workforce optimization. In one embodiment, the workforce outcomes module communicates information regarding the efficiency and effectiveness of deployed personnel to the demand forecast model 110 and the role management module 106.

The demand forecast module 110 forecasts the volume and type of patients that will present. The demand forecast module 110 utilizes data from the other modules and from other systems relating to patterns of registrations, admissions, discharges, transfers by type of patient and department for patient populations over periods of times. These patterns are correlated with environmental factors, such as weather, season, lunar cycles, community health status (e.g. epidemics and general health issues) in order to create predictive models for planning resources and budgets. The module also utilizes patterns of demand for outpatient services based on scheduled services and actual services performed. In one embodiment, information regarding the forecasted demand generated by the demand forecast module is communicated to the work calculation module 102.

The enterprise scheduling module 112 communicates information regarding appointments for outpatient procedures to the staff scheduling and staffing module 104. Once appointments are made for outpatient procedures the staff scheduling and staffing module 104 can estimate the support staff needed for these outpatient procedures.

The registration module 114 provides information regarding patient registration, census and activity. The information regarding the number of patients registered is communicated to the work calculation module 102 to help calculate the work for a patient and/or patient population. An example of a registration module that may be used with the present invention is the Enterprise Registration Management, a solution offered by Cerner Corporation in Kansas City, Mo., under the trademark CERNER MILLENNIUM.

The medical record module 116 includes patient information. For example, the medical record module 116 documents pending orders, admit assessments, completed orders and tasks and anything documented in the primary clinical system. In one embodiment, the information in the medical record module may be obtained by the work calculation module 102 and the severity module 118. An example of a medical record module 116 is provided by the offering branded under the mark POWERCHART by Cerner Corporation in Kansas City, Mo.

The severity module 118 provides information regarding the status and conditions of patients. In one embodiment, this information is communicated to the resource/throughput dashboard module 120. An example of a severity module 118 is the APACHE component provided by Cerner Corporation in Kansas City, Mo.

The departmental patient tracking module 120 tracks the movement and current location of patients through different departments. This information can be communicated to the resource/throughput dashboard module 122. The resource/throughput dashboard module 122 provides views of the demand for services and the resources available to provide those services. The views show existing demand, pending demand from other areas of the organization and capacity to shift workload to other areas of the healthcare organization. The resource dashboard module 122 displays views of activity and capacity in other related departments. For example, in addition to information regarding the ICU, the ICU may have a view of the emergency department, surgery or other related departments or units.

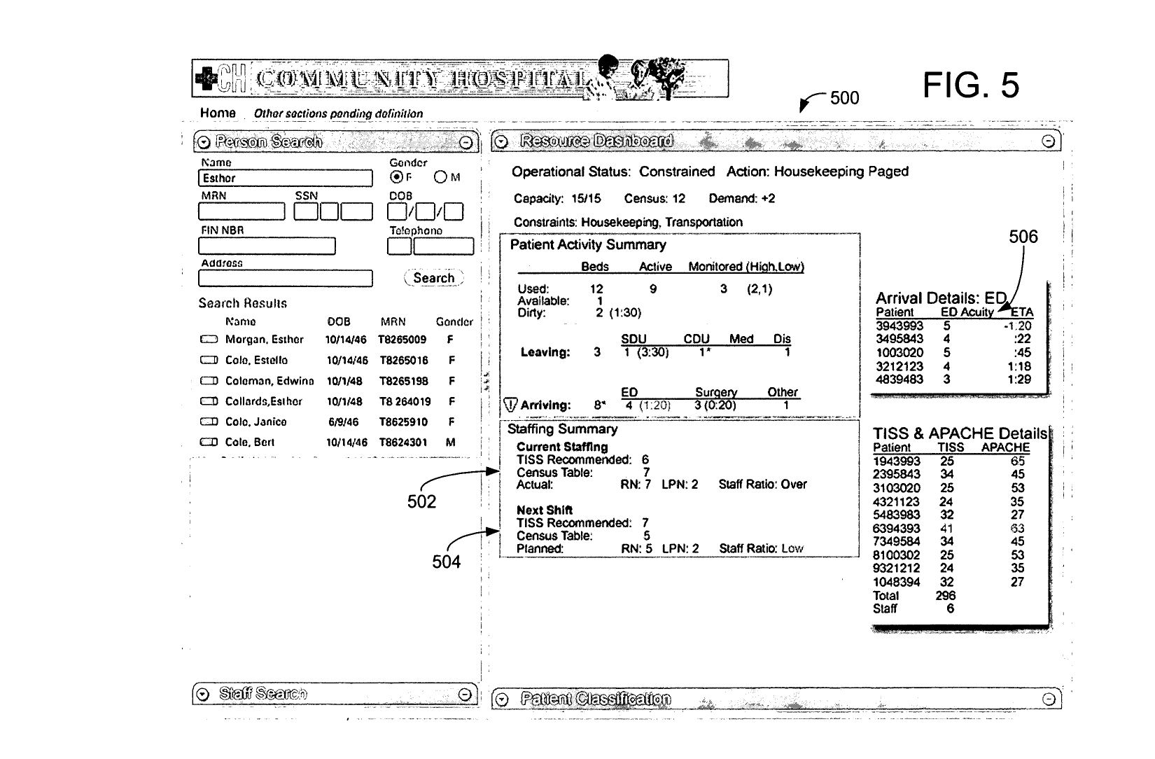

The dashboard module 122 displays information to personnel that they need to make operational decisions to optimize throughput of patients and outcomes of services. In one embodiment, information regarding staff scheduling is received from the staff scheduling module 104 and work calculations for a patient population are received from the work calculation module 102. A view of an exemplary resource dashboard is shown in FIG. 5.

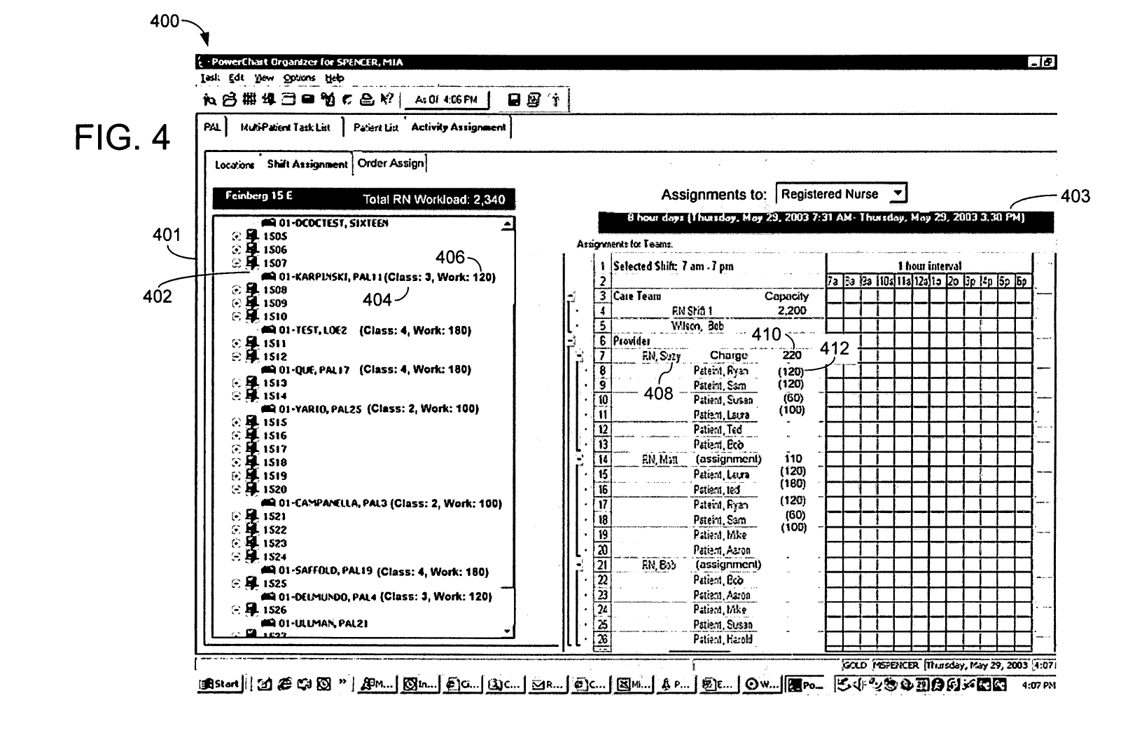

The shift assignment module 124 displays the availability of personnel currently working. In other words, the shift assignment module tracks the workload capacity of individual personnel. An example of a shift assignment screen in shown in FIG. 4. An example of a shift assignment module 124 is the shift assignment module provided by Cerner Corporation in Kansas City, Mo., under the CERNER MILLENNIUM trademark.

The personal work queue module 126 tracks and displays work to be performed by individual personnel. For example, a personal work queue for Nurse Smith could include an order to bathe Patient Davis and an order to start an IV for Patient Jones. An example of a personal work queue module 126 is the PAL module provided by Cerner Corporation in Kansas City, Mo., under the CERNER MILLENNIUM trademark.

Those skilled in the art will appreciate that the present invention contemplates the presence of additional modules and/or sub-modules of the computer system 100, and the modules and/or submodules may be combined with one another and/or separated into new modules and sub-modules.

The present invention may be implemented in a variety of computing system environments. For example, each of the modules and submodules of the computer system 100 may be embodied in an application program running on one or more personal computers (PCs). This computing system environment is only one example of a suitable computing environment and is not intended to suggest any limitation as to the scope of use or functionality of the invention. The invention may also be implemented with numerous other general purpose or special purpose computing system environments or configurations. Examples of other well-known computing systems, environments, and/or configurations that may be suitable for use with the invention include, but are not limited to, server computers, hand-held or laptop devices, multiprocessor systems, microprocessor-based systems, programmable consumer electronics, network PCs, minicomputers, mainframe computers, distributed computing environments that include any of the above systems or devices, and the like.

The invention may be described in the general context of computer-executable instructions, such as program modules. Generally, program modules include routines, programs, objects, components, segments, schemas, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Computers typically include a variety of computer-readable media. Computer-readable media includes any media that can be accessed by a computer and includes both volatile and nonvolatile media, removable and non-removable media. By way of example, and not limitation, computer-readable media may comprise computer storage media and communications media. Computer storage media include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD), holographic or other optical storage, magnetic cassettes, magnetic tape, magnetic disk storage or other magnetic storage devices, or any other medium which can be used to store the desired information and which can be accessed by a computer.

Communications media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communications media includes wired media such as a wired network or direct wired connection, and wireless media such as acoustic, RF, infrared, spread spectrum and other wireless media. Communications media are commonly used to upload and download information in a network environment, such as the Internet. Combinations of any of the above should also be included within the scope of computer-readable media.

The computer may operate in a networked environment using logical connections to one or more remote computers, such as a personal computer, a server, a router, a network PC, a peer device or other common network node, and typically includes many or all of the elements described above. The logical connections may include connections to a local area network (LAN), a wide area network (WAN) and/or other networks. Such networking environments are commonplace in offices, enterprise-wide computer networks, intranets and the Internet.

Computer storage mechanisms and associated media provide storage of computer-readable instructions, data structures, program modules and other data for the computer. A user may enter commands and information into the computer through input devices such as a keyboard and pointing device, commonly referred to as a mouse, trackball or touch pad. Other input devices may include a microphone, touchscreen, camera, joystick, game pad, scanner, or the like. In addition to a monitor or other type of display device, computers may also include other peripheral output devices such as speakers and printers, which may be connected through an output peripheral interface.

Although many other internal components of computers have not been discussed herein, those of ordinary skill in the art will appreciate that such components and their interconnection are well-known. Accordingly, additional details concerning the internal construction of computers need not be disclosed in connection with the present invention.

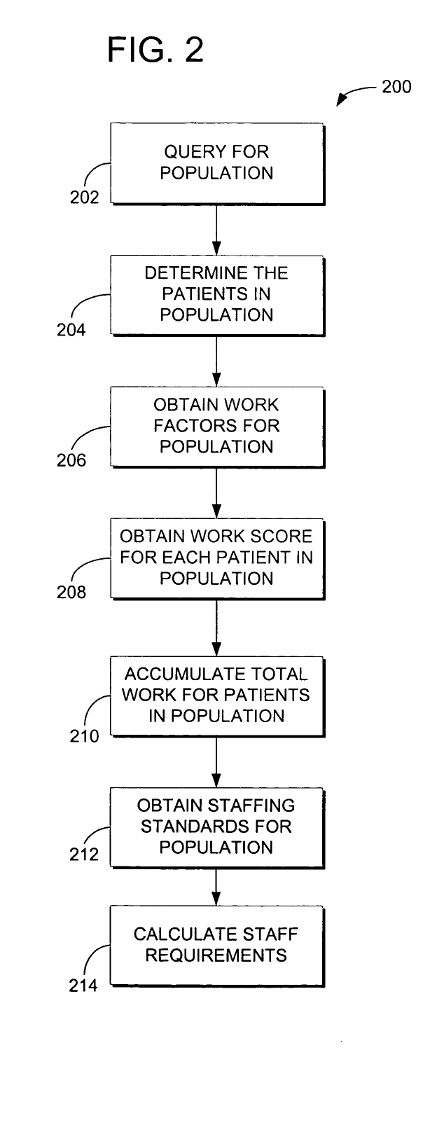

Referring next to FIG. 2, an embodiment of the present invention, a method 200 for calculating the amount of work for a particular patent population, is described. The amount of work includes a patient classification score, a workload score or any value that reflects the work or time it takes to treat a patient or patient population. At block 202, the system receives a query for the amount of work for a particular population. The query may be a request embedded in the primary clinical system to be done at scheduled times or the request may be from a user who wants to determine the amount of work for a particular population. The particular population may be defined by a location, diagnosis, cost center, functional center, nursing unit, organization, department, attending physician and procedures. For example, the particular request may be for all patients being treated by the attending physician Smith, all patients in the ICU nursing unit or all patients needing respiratory therapy.

At block 204 the system determines or identifies the patients in the population. In one embodiment, this is performed by accessing the patient's electronic medical record to determine whether or not they are in the particular population being queried.

At block 206 the system obtains the work factors for the particular population. For each population there is a template of factors that indicate work for the particular population. For instance, an intensive care unit (ICU) patient population would have a catalog of factors relating to work in the ICU including, but not limited to, whether the patient is on a respirator, how many IV medications they have started, feeding and hygiene needs. Work factors for patients with respiratory therapy orders may include specific breathing treatments or equipment. The factors may vary from population to population, and the same factor may be used differently on the same population by care providers with different responsibilities.

The work factors may be imported from a third party, or created specifically for the organization, and stored in the catalog within system. Work factors may be factors related to any methodology including workload factors (relative value units), patient classification factors or any other factors that assign a patient classification value or an amount of work to an activity or event. Multiple methodologies can be applied concurrently to calculate workload for different types of staff members for the same patient population.

Each factor also is assigned one or more clinical event triggers. Triggers may be services that are planned, intended or typically delivered for a specific patient or patient type, outstanding electronic orders, tasks, documentation of a completed order or task, services provided by personnel over a period of time, scheduled procedures or outpatient care, assigned tasks or orders, assessments or any other “triggers” that may associated with workload. Further, factors may be triggered manually. Using the example above, if giving a patient a bath is a factor for a nursing unit population, the clinical event trigger may be an order for a patient to be bathed. The trigger can have multiple states that indicate whether a prospective or retrospective workload score should be used. An order that is not completed can trigger prospective workload while the same order in a completed status can trigger retrospective or actual workload.

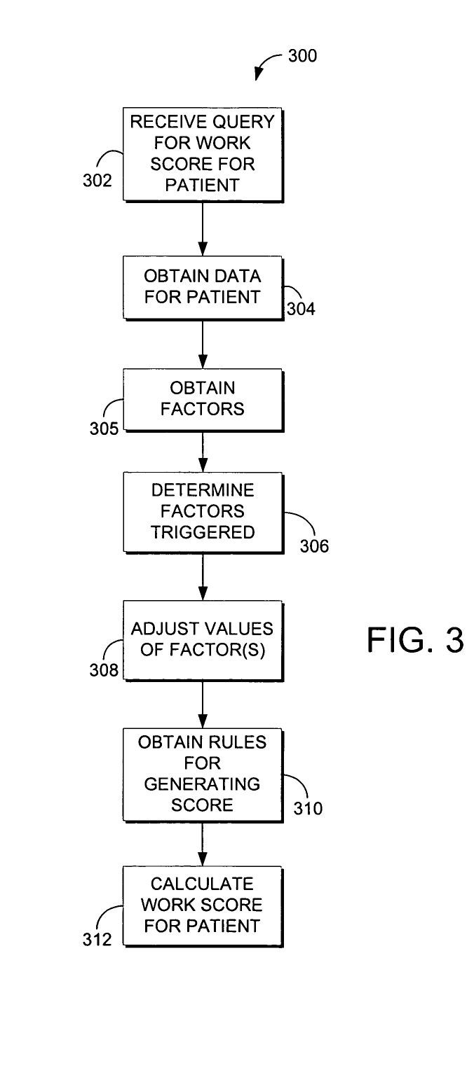

At block 208, the system obtains a work score for each patient in the population. The work score may be a patient classification score, a workload score or any other value that assigns a classification value or an amount of work to the patient. With reference to FIG. 3, a method for obtaining a work score for a patient is described. At block 302 the system receives a query for a work score for a patient. The system may receive the query from the method described in FIG. 2, from another method or system or directly from a user. At block 304, the system obtains data/information for the patient directly from the primary clinical information system. The patient data/information may include outstanding orders, admit assessments, services provided and any information regarding the patient. In one embodiment, the system obtains information from the electronic medical record of a user. In another embodiment, the method and system captures information when healthcare professionals plan, provide and document care.

At block 305 the system obtains work factors for the patient. The factors may be obtained from the method described in FIG. 2 relating to the patient population or may be obtained from the clinical information system.

At block 306 the system determines whether each factor is triggered by information obtained directly from the primary clinical information system. For example, if one of the factors for determining a work score for a patient in the patient population for the ICU is starting an IV, the method can poll the activity in the primary clinical information system to determine whether an IV has been ordered or documented for a particular patient.

Each triggered factor has an assigned weight or an adjustable weight. For instance, a factor may always have the same value or may a different weight depending on the population. Rules may also be applied to adjust the value of the factor. For instance, giving a patient a bath is a factor and is assigned a relative value unit of two. However, there is a rule in the system that adjusts the weight of the factor depending on the weight or age of the patient. Thus, if a bath is being given to a five year old patient, the relative value unit may be adjusted to three to compensate for the extra time needed to bathe a five year old. These rules are user-defined. An example of a rules module is Discern Expert component of software provided by Cerner Corporation in Kansas City, Mo. under the trademark CERNER MILLENNIUM.

At block 308, if needed, the system adjusts the value of the triggered factors if a rule is satisfied as discussed above. Next, at block 310, the system obtains the rules for generating a work score for a patient. The rules for generating a work score may be any rules for obtaining the score needed. For instance, the rule may require that all the values for all the triggered factors be added to generate the score. Or the rule for generating a score may be to add all the values, compare the value with a series of ranges of values, and assign a work score for the patient related to the range in which the value falls.

At block 312, the system utilizes the rules for generating a score and the factors with their assigned values to calculate a work score for the patient. The work score can be a workload score (e.g. relative value units), a patient classification score of any another score that may ultimately reflect the amount of work or time it takes to treat a patient. Furthermore, the system may generate retrospective work score and/or a prospective work score.

A prospective work score is based on services that are planned, intended, or typically delivered for a specific patient or patient type. Prospective work scores consider all outstanding orders, admit assessments and other indicators of work available in the system to predict work totals for periods of time or shifts.

A retrospective work score is calculated based on services that have been provided by hospital personnel over a period of time. The work may be an estimated value for the procedure or service or may be captured discretely in the system where start and stop times are recorded.

In one embodiment, the work score is sent to the patient's electronic chart so that it may be obtained by a healthcare provider. For example, if a work score is calculated for a patient in the ICU population, an ICU nurse can obtain the patient's work score relating to the ICU nursing care required by the patient. If a respiratory therapist opens the patient's electronic chart, the respiratory therapist obtains the patient's work score relating to the respiratory therapy orders. As such, the ICU nurse and the respiratory therapist would see different work scores based on different work factors relating to the same population.

In another embodiment, the work score for the patient and/or all patients in a particular population is sent to the staff assignment module discussed above. With reference to FIG. 4, an exemplary display of the staff assignment module 400 is shown. Field 401 includes information regarding the work score calculation 404, 406 for one or more patients 402. As can be seen in the exemplary display, the work calculation module has calculated work scores for a fictitious patient. The fictitious patient has a patient classification score of “3” and a workload score of “120”. Field 403 includes information regarding the staff 408 currently on duty and their work capacity 410. As can be seen in FIG. 4, fictitious Nurse Suzy is responsible for caring for six patients 412. She has a workload capacity of 220 relative value units (RVUs). In this example, a nurse manager would be able to see from the staff assignment display that Nurse Suzy has the capacity (220 RVU) to handle fictitious Patient Karpinski who has a workload of 120 RVUs. If the nurse manager assigns Patient Karpinski to Nurse Suzy, she will have a 100 RVU capacity left. From this display, a nurse manager can easily see the work capacity of nurses in the unit and all patients who have not been assigned and can easily assign patients to nurses who display work capacity to handle additional patients.

Referring again to FIG. 2, after a work score is obtained for each patient in the particular patient population, at block 210 the system accumulates the total work for patients in the particular population. At block 212, the system obtains the staffing standards for the particular population. The staffing standards are obtained from a database contained within the system, which is integrated with (or is one in the same with) the primary clinical information system. The system also determines whether there are any governmental regulations that must be taken into consideration when calculating staff requirements. For example, according to staffing standards one registered nurse can care for three patients with a level “5” patient classification work score. However, according to governmental regulations one registered nurse can care for two patients with a level “5” patient classification work score. In another example, the staffing standards may indicate that only one nurse is required to manage four patients in the ICU based on their low acuity, however, government regulations require a ratio of one nurse per every two patients in the ICU.

At block 214, the system applies the staffing standards to the work scores obtained for patients in the particular population and calculates the staff requirements needed for the particular population. This information may be sent to the staff scheduling and staffing module discussed above. In another embodiment, the staff requirements are sent to the resource/throughput dashboard module. With reference FIG. 4, a display of the resource dashboard 500 for emergency department is shown. Field 501 shows the emergency department quick view. The work calculation module has applied the staffing standards for the ER to the work scores for ER patients and calculated the staff requirements needed for the ER population. The work calculation module has calculated the staff requirements for both the current staff scheduled 502 and the prospective staff scheduled 504. As can be seen from the display, there are too many registered nurses (RN) and LPNs scheduled for the number of patients in the ER based on the calculated staff requirements. As such, the current staff ratio is “over”. The system has also calculated the staff ratio needed for the upcoming shift based on information obtained from the system. For the upcoming shift there are not enough RNs or LPNs scheduled. The staff ratio for the next shift is “Low.” The next shift starts in 2.2 hours and this is enough time for a nurse manager to try to schedule additional personnel before the next shift begins. The resource dashboard also shows the work score 506 for patients arriving in the Emergency Department. The work score 506 is a patient classification/acuity score for each patient.

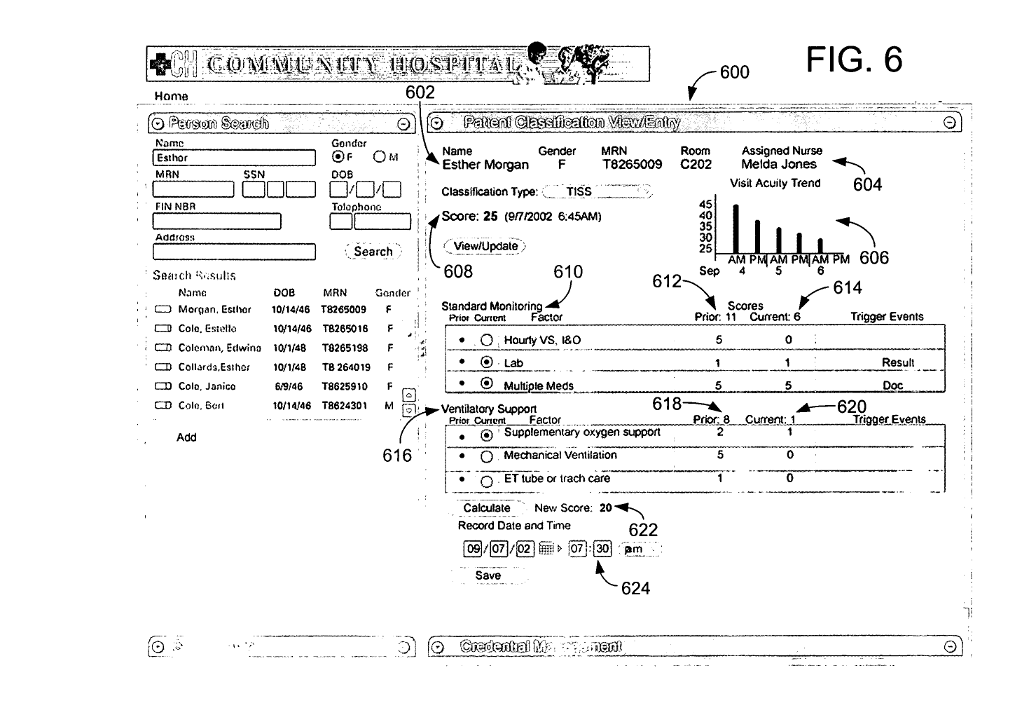

Referring to FIG. 6, a view of the work calculation/patient classification screen 600 for a fictitious patient Esther Morgan 602 is shown. The patient's current work score 608 is 25. A trend 606 of the patient's work scores through Sep. 4, 2003 through Sep. 6, 2003 is also shown. The factors taken into account for the amount of work for the nursing unit are shown in fields 610 and 616. The patient's prior work scores 612 and current work scores 614 for each standard monitoring factor are shown. The patient's prior work scores 618 and current work scores for 620 each ventilator support factors are also shown. The new work score 622 was calculated at 7:30 p.m. on Sep. 7, 2002 by adding together all of the current work scores 614 and 620. The new work score for patient Morgan is “20”.

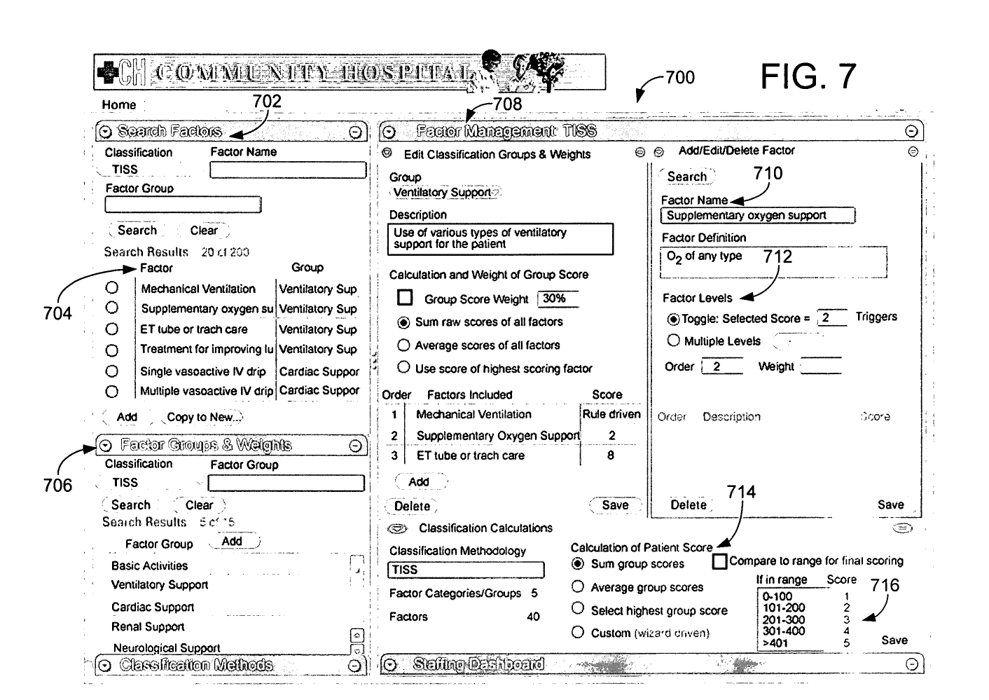

Referring next to FIG. 7, a factor management screen 700 is shown. The factor management provides a field 702 for searching for factors. The queried factors are listed in field 704. The system also provides a field 706 allowing factors to be grouped. The factor management field 708 contains the factor name 710, a factor definition and a factor level 712. Field 714 and 716 are used for determining how a work score will be calculated.

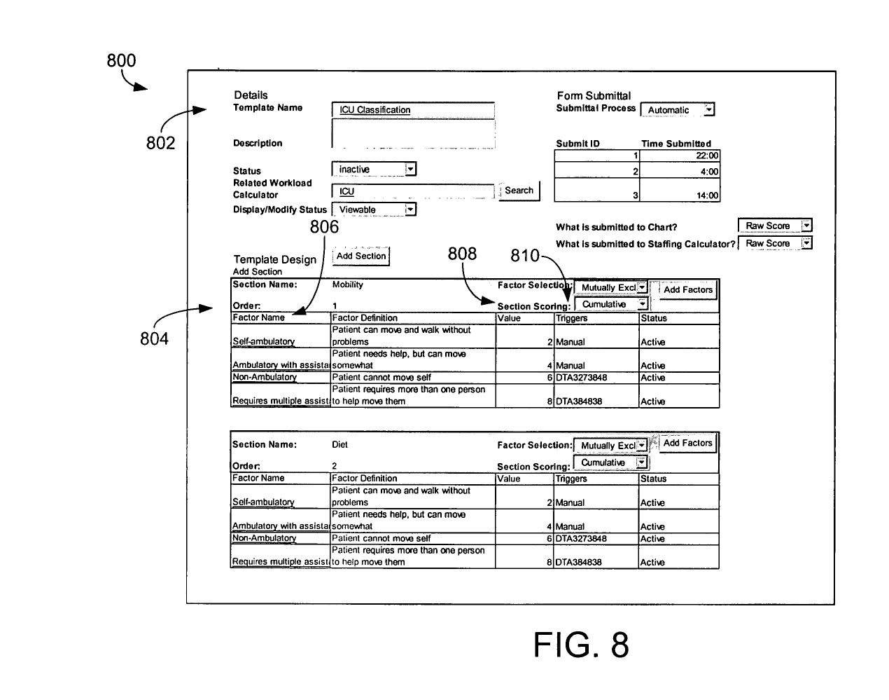

With reference to FIG. 8, a template screen 800 is shown. The template 802 is for factors used to calculate a work score for one or more patients in the ICU. The template design field 804 contains the factor name 806, the value of the factor 808 if triggered, and the clinical information 810 that triggers the factors in the template.

Although the invention has been described with reference to the preferred embodiment illustrated in the attached drawing figures, it is noted that substitutions may be made and equivalents employed herein without departing form the scope of the invention as recited in the claims. For example, additional steps may be added and steps omitted without departing from the scope of the invention.

1. A method in a computing environment for determining the work for one or more patients, the method comprising:
obtaining data for one or more patients directly from the primary clinical information system; and
utilizing the data to calculate a work score for the one or more patients.

2. The method of claim 1, further comprising:
receiving a request for a work score for the one or more patients.

3. The method of claim 2, further comprising:
obtaining factors that indicate work for the one or more patients.

4. The method of claim 3, further comprising:
determining which of the factors are triggered by the data for the one or more patients.

5. The method of claim 4, wherein each factor has one or more assigned values.

6. The method of claim 5, further comprising:
adjusting the value of one or more triggered factors based on rules if needed.

7. The method of claim 5, further comprising:
obtaining rules for generating a work score for each of the one or more patients.

8. The method of claim 7, further comprising:
utilizing the rules and triggered factor values to generate a work score for each of the one or more patients.

9. The method of claim 1, wherein the data is one of outstanding orders, outstanding tasks, completed orders, completed tasks, services provided by personnel over a period of time, scheduled procedures, scheduled outpatient care, assigned tasks, assigned orders, assessments, tasks, services typically delivered for a specific patient or patient type and combinations thereof.

10. The method of claim 1, wherein the work score is prospective.

11. The method of claim 1, wherein the work score is retrospective.

12. A method in a computing environment for determining the work for a population of patients, the method comprising:
utilizing data obtained directly from the primary clinical information system to calculate a work score for each patient in a patient population; and
calculating staffing needs for the population based on the work scores obtained for the patients in the patient population.

13. The method of claim 12, further comprising:
receiving a request for the work for the patient population.

14. The method of claim 13, further comprising:
determining the patients in the population.

15. The method of claim 14, further comprising:
obtaining the work factors for the population.

16. The method of claim 15, further comprising:
determining which of the factors are triggered by the data for each patient in the population.

17. The method of claim 15, wherein each factor has an assigned value.

18. The method of claim 17, further comprising:
adjusting the value of one or more triggered factors if needed.

19. The method of claim 17, further comprising:
obtaining rules for generating a work score for each patient in the population.

20. The method of claim 19, further comprising:
utilizing the rules and triggered factor values to generate a work score for each patient in the population.

21. The method of claim 20, further comprising:
accumulating the work scores for all patients in the population.

22. The method of claim 21, further comprising:
obtaining staffing standards for the population.

23. The method of claim 22, further comprising:
calculating staffing needs based on the work scores obtained for the patients in the patient population and the staffing standards for the population.

24. The method of claim 12, wherein the data is one of outstanding orders, outstanding tasks, completed orders, completed tasks, services provided by personnel over a period of time, scheduled procedures, scheduled outpatient care, assigned tasks, assigned orders, assessments, tasks, services typically delivered for a specific patient or patient type and combinations thereof.

25. A computer system for determining the work for one or more patients, the system comprising:
means for obtaining data for one or more patients directly from the primary clinical information system; and
means for utilizing the data to calculate a work score for the one or more patients.

26. The system of claim 25, further comprising:
means for obtaining factors that indicate work for the one or more patients.

27. The system of claim 26, further comprising:
means for determining which of the factors are triggered by the data for the one or more patients.

28. The system of claim 27, further comprising:
means for obtaining rules for generating a work score for each of the one or more patients.

29. The system of claim 28, further comprising:
means for utilizing the rules and triggered factor values to generate a work score for each of the one or more patients.

30. A computer system for determining the work for a population of patients, the system comprising:
means for utilizing data obtained directly from the primary clinical information system to calculate a work score for each patient in a patient population; and
means for calculating staffing needs for the population based on the work scores obtained for the patients in the patient population.

31. The system of claim 30, further comprising:
means for determining the patients in the population.

32. The system of claim 31, further comprising:
means for obtaining the work factors for the population.

33. The system of claim 32, further comprising:
means for determining which of the factors are triggered by the data for each patient in the population.

34. The system of claim 33, further comprising:
means for obtaining rules for generating a work score for each patient in the population.

35. The system of claim 34, further comprising:
means for utilizing the rules and triggered factor values to generate a work score for each patient in the population.

36. The system of claim 35, further comprising:
means for accumulating the work scores for all patients in the population.

37. The system of claim 36, further comprising:
means for obtaining staffing standards for the population.

38. The system of claim 37, further comprising:
means for calculating staffing needs based on the work scores obtained for the patients in the patient population and the staffing standards for the population.

39. A computer-readable medium having computer-executable instructions for performing a method, the method comprising:
obtaining data for one or more patients directly from the primary clinical information system; and
utilizing the data to calculate work for the one or more patients.

40. A computer-readable medium having computer-executable instructions for performing a method, the method comprising:
utilizing data obtained directly from the primary clinical information system to calculate a work score for each patient in a patient population; and
calculating staffing needs for the population based on the work scores obtained for the patients in the patient population.

41. A computerized system for optimizing personnel planning in a healthcare organization, the system comprising:
a work calculation module for calculating a work score for one or more patients;
a staff scheduling and staffing module for identifying healthcare personnel positions to be filled;
role management module for managing the roles and information regarding personnel;
a workforce outcomes module for determining how effectively healthcare personnel have been used;
a demand forecast module for forecasting the volume and type of patients who will present; and
a resource dashboard module for displaying information regarding personnel and patients.

42. The system of claim 41, further comprising:
an enterprise scheduling module for identifying information regarding appointments for outpatient procedures.

43. The system of claim 42, further comprising:
a shift assignment module for displaying one of the capacity, availability and combinations thereof of personnel currently working.

44. The system of claim 43, further comprising:
a registration module for identifying and tracking patient registration, census and activity.

45. The system for claim 44, further comprising:
a medical records module for capturing and storing patient data.

46. The system of claim 45, further comprising:
a patient severity module for providing information regarding the status and conditions of patients.

47. The system of claim 46, further comprising:
a departmental tracking module for tracking patients through different departments.

48. The system of claim 47, further comprising:
a personal work queue module for tracking and displaying work to be performed by individual personnel.
